(19) United States
(12) Patent Application Publication
(10) Pub. No.: US 2013/0260027 A1
(43) Pub. Date: Oct. 3, 2013

(54) METHOD FOR MANUFACTURING GLASS SUBSTRATE FOR MAGNETIC DISK, AND METHOD FOR MANUFACTURING MAGNETIC DISK

(71) Applicants: Kyosuke IIIzumi, Shinjuku-ku (JP); Yoshihiro Tawara, Shinjuku-ku (JP); Kotaro Yoshimaru, Shinjuku-ku (JP)

(72) Inventors: Kyosuke IIIzumi, Shinjuku-ku (JP); Yoshihiro Tawara, Shinjuku-ku (JP); Kotaro Yoshimaru, Shinjuku-ku (JP)

(73) Assignee: HOYA CORPORATION, Shinjuku-ku, Tokyo (JP)

(21) Appl. No.: 13/991,003

(22) PCT Filed: Dec. 29, 2011
(86) PCT No.: PCT/JP2011/007370

§ 371 Date: May 31, 2013

Related U.S. Application Data
(60) Provisional application No. 61/428,027, filed on Dec. 29, 2010.

(51) Int. Cl. G11B 5/84

(52) U.S. Cl. CPC G11B 5/8404
USPC 427/128; 216/53

(57) ABSTRACT

Provided are: a method for manufacturing a glass substrate for a magnetic disk by using an alternative abrasive having the same polishing performance as cerium oxide, which has conventionally been used as an abrasive for polishing principal faces of glass substrates for magnetic disks; and a method for manufacturing a magnetic disk. At the time of polishing a principal face of a magnetic disk glass substrate by using a slurry, the disclosure employs a slurry containing: an abrasive made of granular zirconia; a first additive including a phosphate and/or a sulfonate; and a second additive including a re-aggregation inhibitor.

### TECHNICAL FIELD

The present invention relates to a method for manufacturing a glass substrate for a magnetic disk, and a method for manufacturing a magnetic disk.

### BACKGROUND ART

Recent devices, including personal computers and DVD (Digital Versatile Disc) recorders, have built-in HDDs (Hard Disk Drives) for recording data. The HDDs, used for portably designed machines such as laptop PCs, are provided with a magnetic disk formed by a glass substrate with a magnetic layer disposed thereon. The HDDs are configured to record/reproduce magnetic recording information in/out of the magnetic layer by using a magnetic head (a DFH (Dynamic Flying Height) head) that floats slightly above the magnetic disk face. Glass substrates have been preferably used as the substrates for the magnetic disks, because they are less prone to plastic deformation compared to metal substrates (e.g., aluminum substrates) and so forth.

Meanwhile, development of high-density magnetic recording has been underway for meeting the demand of increasing the storage volume of HDDs. For example, the magnetic recording information area is minutely divided by means of a perpendicular magnetic recording method for perpendicularly directing the magnetization direction in the magnetic layer with respect to the substrate face. Accordingly, the storage volume can be increased in a single disk substrate. Further, enhancement in the accuracy of recording/reproducing information (i.e., enhancement in S/N ratio) has also been underway by significantly reducing the floating distance between the magnetic head and the magnetic recording surface in order to further increase the storage volume. In such magnetic disk substrates, the magnetic layer is formed flatly such that the magnetization direction of the magnetic layer is oriented substantially perpendicularly to the substrate face. To achieve this, magnetic disk substrates are fabricated such that their surface asperities are made as small as possible.

Steps of fabricating a glass substrate for a magnetic disk involve: a grinding step of executing grinding by using fixed abrasive grains with respect to a principal face of a plate glass material which has been formed into a flat plate shape after press-molding; and a polishing step of executing polishing with respect to the principal face for removing flaws and distortion left on the principal face due to the grinding step.

For the aforementioned polishing step with respect to the principal face, a method of using cerium oxide (cerium dioxide) abrasive grains as an abrasive has been conventionally known (Patent Literature 1). With this method using cerium oxide abrasive grains as an abrasive, distortion and flaws remaining on the principal face of a glass substrate for magnetic disks can be removed at a high polishing rate, and the principal face can efficiently be provided with surface asperities required of glass substrates for magnetic disks.

### CITATION LIST

### Patent Literature

Patent Literature 1: JP-A-2008-254166

### SUMMARY OF INVENTION

### Technical Problem

Incidentally, in recent years, it is becoming more difficult to stably procure cerium, which is a rare-earth element, and the cost of cerium is soaring accordingly. Thus, there have been demands for the development of abrasives to replace cerium oxide, also in the field of manufacturing glass substrates for magnetic disks.

Zirconia (zirconium dioxide) is commonly known as an abrasive for glass-made industrial products. It is conceivable to use zirconia as a substitute for cerium oxide. However, there are difficulties in using zirconia as-is as an abrasive for the fabrication of glass substrates for magnetic disks. That is, if a glass substrate for a magnetic disk is fabricated by using a slurry containing loose abrasive grains consisting only of zirconia, then polishing performance—such as the polishing rate of the principal faces of the glass substrate, accuracy in surface asperities on the principal faces, the presence/absence of scratches on the principal faces, and production stability (amount of reduction in polishing rate from batch to batch)—will deteriorate compared to cases of using cerium oxide. Thus, an abrasive including only zirconia cannot be used as-is as a substitute for cerium oxide.

Accordingly, an objective of the present invention is to provide: a method for manufacturing a glass substrate for a magnetic disk by using an alternative abrasive having the same polishing performance as cerium oxide, which has conventionally been used as an abrasive for polishing principal faces of glass materials, in order to fabricate a glass substrate for a magnetic disk; and a method for manufacturing a magnetic disk.

### Solution to Problem

As a result of diligently studying the above problem, Inventors have found that the same polishing performance as cerium oxide, which has conventionally been used as an abrasive, can be achieved by using a slurry containing predetermined additives in addition to zirconia serving as an abrasive.

More specifically, the present invention is a method for manufacturing a glass substrate for a magnetic disk, the method involving a step of polishing a principal face of a glass material by using a slurry, wherein the slurry contains: an abrasive made of granular zirconia; a first additive including at least one type of compound selected from the group consisting of phosphates, sulfonates, polycarboxylic acids, and polycarboxylates; and a second additive including a re-aggregation inhibitor.

In the method for manufacturing a glass substrate for a magnetic disk according to the present invention, it is preferable that the average particle size (D₅₀) of the zirconia is from 0.2 to 10 μm.

In the method for manufacturing a glass substrate for a magnetic disk according to the present invention, it is preferable that the slurry contains 5 to 20 wt % of the abrasive, 0.01 to 5 wt % of the first additive, and 0.01 to 5 wt % of the second additive.

In the method for manufacturing a glass substrate for a magnetic disk according to the present invention, it is preferable that the re-aggregation inhibitor is at least one type of compound selected from the group consisting of cellulose, carboxymethyl cellulose, maltose, and fructose.

In the method for manufacturing a glass substrate for a magnetic disk according to the present invention, it is preferable that the slurry further contains a third additive including granular silicon dioxide and/or titanium dioxide having a smaller particle size than the zirconia.

In the method for manufacturing a glass substrate for a magnetic disk according to the present invention, it is preferable that the average particle size (D₅₀) of the silicon dioxide and/or titanium dioxide is from 10 to 100 nm.

In the method for manufacturing a glass substrate for a magnetic disk according to the present invention, it is preferable that the slurry contains 0.1 to 20 wt % of the third additive.

In the method for manufacturing a glass substrate for a magnetic disk according to the present invention, it is preferable that the pH of the slurry is from 6 to 12.

In the method for manufacturing a glass substrate for a magnetic disk according to the present invention, it is preferable that the glass substrate for a magnetic disk is made of aluminosilicate glass having a composition containing, in an oxide-based conversion indicated in mol %: 50 to 75% of SiO₂; 1 to 15% of Al₂O₃; a total of 12 to 35% of at least one type of component selected from Li₂O, Na₂O, and K₂O; a total of 0 to 20% of at least one type of component selected from MgO, CaO, SrO, BaO, and ZnO; and a total of 0 to 10% of at least one type of component selected from ZrO₂, TiO₂, La₂O₃, Y₂O₃, Ta₂O₅, Nb₂O₅, and HfO₂.

A method for manufacturing a magnetic disk according to the present invention is characterized by forming at least a magnetic layer on a glass substrate for a magnetic disk manufactured according to the aforementioned method for manufacturing a glass substrate for a magnetic disk.

### Advantageous Effects of Invention

With the method for manufacturing a glass substrate for a magnetic disk and the method for manufacturing a magnetic disk according to the present invention, the same polishing performance as cerium oxide, which has conventionally been used as an abrasive, can be achieved by using a slurry containing predetermined additives in addition to zirconia serving as an abrasive in polishing a principal face of a glass material in order to fabricate a glass substrate for a magnetic disk.

### BRIEF DESCRIPTION OF DRAWINGS

FIG. 1 is a schematic cross-sectional view of a polisher device (double-face polisher device) to be used in a first polishing step.

### DESCRIPTION OF EMBODIMENTS

A method for manufacturing a glass substrate for a magnetic disk according to the present exemplary embodiment will be described in detail below.

{Glass Substrate for Magnetic Disk}

Aluminosilicate glass, soda-lime glass, borosilicate glass, or the like can be used as a material of a glass substrate for a magnetic disk (also referred to as “magnetic disk glass substrate”) in the present exemplary embodiment. Amongst the above, aluminosilicate glass can preferably be used especially in that it can be chemically strengthened and enables fabrication of a magnetic disk glass substrate in which the principal faces have excellent flatness and the substrate has excellent strength.

The composition of the magnetic disk glass substrate of the present exemplary embodiment is not limited. However, the glass substrate of the present exemplary embodiment is preferably aluminosilicate glass having a composition containing, in an oxide-based conversion indicated in mol %: 50 to 75% of SiO₂; 1 to 15% of Al₂O₃; a total of 12 to 35% of at least one type of component selected from Li₂O, Na₂O, and K₂O; a total of 0 to 20% of at least one type of component selected from MgO, CaO, SrO, BaO, and ZnO; and a total of 0 to 10% of at least one type of component selected from ZrO₂, TiO₂, La₂O₃, Y₂O₃, Ta₂O₅, Nb₂O₅, and HfO₂.

The magnetic disk glass substrate of the present exemplary embodiment is an annular thin-plate glass substrate. The size of the magnetic disk glass substrate is not particularly limited. However, the magnetic disk glass substrate preferably has a nominal diameter of 2.5 inches, for instance.

{Method for Manufacturing Glass Substrate for Magnetic Disk}

A method for manufacturing a magnetic disk glass substrate according to the present exemplary embodiment will be hereinafter explained on a step-by-step basis. It should be noted that the order of the steps may be arbitrarily changed.

(1) Molding of Plate Glass and Lapping Step

For example, in a step of molding a plate glass by using a float method, molten glass having e.g., the aforementioned composition is firstly poured continuously into a tub filled with molten metal, e.g., tin, in order to obtain a plate glass. The molten glass flows along a travel direction within the strictly temperature-controlled tub, and a plate glass having a thickness and width regulated to desired dimensions is finally produced. Through the cutting of the plate glass, a plate glass material with a predetermined shape is obtained as a blank of the magnetic disk glass substrate. The plate glass material obtained by the float method has a sufficiently flat surface due to the horizontal surface of the molten tin filled in the tub.

On the other hand, in a step of molding the plate glass by using press-molding, for instance, glass gob made of molten glass is supplied to a bottom mold, which serves as a receiver gob forming mold. Subsequently, the glass gob is press-molded using the bottom mold and a top mold, which serves as an opposed gob forming mold. More specifically, the glass gob made of molten glass is supplied onto the bottom mold, and subsequently, the bottom face of a top-mold side barrel and the top face of a bottom-mold side barrel are contacted to each other. Accordingly, a thin plate glass molding space is externally produced across a slid surface between the top mold and the top-mold side barrel and a slid surface between the bottom mold and the bottom-mold side barrel. Further, the top mold is lowered for executing press-molding and is then elevated immediately after the press-molding. Accordingly, a plate glass material is formed as the blank of the magnetic disk glass substrate.

It should be noted that the method of manufacturing the plate glass material is not limited to the above. For example, the plate glass material can be manufactured using any suitable heretofore known manufacturing methods such as a down-draw method, a re-draw method and a fusion method.

Next, on an as-needed basis, a lapping processing using alumina-based loose abrasive grains is executed for both principal faces of the plate glass material, which has been cut in a predetermined shape. Specifically, the lapping processing is executed as follows. First, top and bottom lap platens are pressed onto both principal faces of the plate glass material. Grinding liquid (slurry) containing loose abrasive grains is supplied onto the principal faces of the plate glass material. Under this condition, the top and bottom lap platens are moved relatively to each other. It should be noted that, when the plate glass material is molded by means of a float method, the post-molding principal faces have a highly accurate surface roughness, so in this case, the lapping processing may be omitted.

The steps described below are for cases where the disc-shaped glass material is made by press-molding.

(2) Coring Step

An annular glass substrate is produced by forming an inner hole in the center part of the disc-shaped glass material by using a cylindrical diamond drill.

(3) Chamfering Step

A chamfering step is executed for forming chamfered faces on the edges (i.e., inner and outer peripheral edge faces) after execution of the coring step. In the chamfering step, chamfering is executed for the inner and outer peripheral surfaces of the laminate, which has been processed into an annular shape through the coring step, by means of, for instance, a metal bond abrasive block using diamond abrasive grains.

(4) Edge Face Polishing Step (Machining Step)

Next, edge face polishing (edge polishing) is executed for the annular plate glass material.

In edge polishing, mirror finishing is executed for the inner and outer peripheral edge faces of the annular plate glass material by means of brush polishing. Slurry containing fine particles of e.g., cerium oxide as loose abrasive grains is used herein. Contamination (attachment of dirt, etc.) and breakage (damage, flaws, etc.) on the edge faces of the annular plate glass material are eliminated by means of edge polishing. It is thereby possible to prevent occurrence of thermal asperities and deposition of ions (sodium, potassium, etc.) that causes corrosion.

(5) Grinding Step Using Fixed Abrasive Grains

In a grinding step using fixed abrasive grains, the principal faces of the annular plate glass material are ground by a double-face grinder device. For example, the removal stock for grinding is set to be roughly several μm to 100 μm. The double-face grinder device includes a pair of platens (i.e., top and bottom platens). The annular plate glass material is interposed and held between the top and bottom platens. Subsequently, the annular plate glass material and the respective top and bottom platens are moved relatively to each other by operating and moving either or both of the top and bottom platens. Accordingly, both the principal faces of the annular plate glass material can be ground.

(6) First Polishing (Principal Face Polishing) Step

Next, a first polishing step is executed for the ground principal faces of the annular plate glass material. For example, the removal stock for the first polishing step is set to be roughly several μm to 50 μm. It is an objective of the first polishing step to eliminate flaws and distortion left on the principal faces after the grinding step using the fixed abrasive grain and to regulate waviness or micro-waviness.

{Polisher Device}

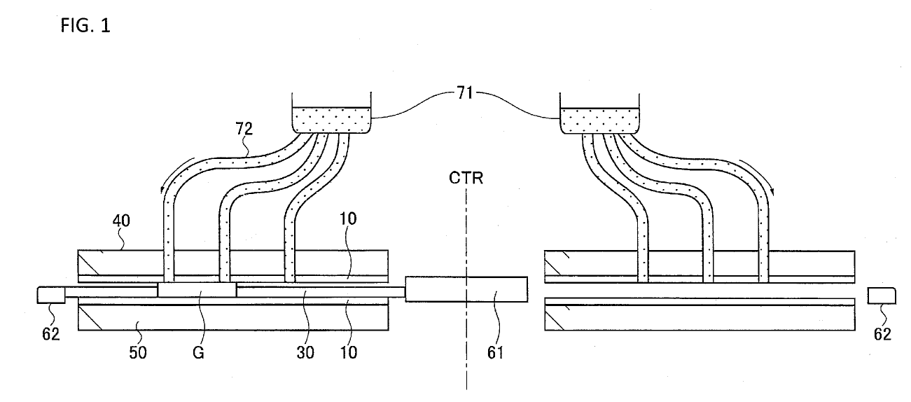

The polisher device to be used in the first polishing step will be hereinafter explained with reference to FIG. 1. FIG. 1 is a schematic cross-sectional view of the polisher device (double-face polisher device) to be used in the first polishing step. It should be noted that the structure of the polisher device may be applied to the grinder device to be used in the aforementioned grinding step.

As illustrated in FIG. 1, the polisher device includes a pair of top and bottom platens—i.e., a top platen 40 and a bottom platen 50. A plate glass material G is interposed and held between the top platen 40 and the bottom platen 50. The plate glass material G and the respective top and bottom platens 40 and 50 are moved relatively to each other by operating and moving either or both of the top and bottom platens 40 and 50. Accordingly, both principal faces of the plate glass material G can be polished.

The structure of the polisher device will be explained more specifically with reference to FIG. 1.

In the polisher device, polisher pads 10 are attached respectively to the top face of the bottom platen 50 and the bottom face of the top platen 40. Each polisher pad 10 is a flat plate member formed in an entirely annular shape. A planetary gear mechanism is formed, as a whole, about a center axis CTR by a sun gear 61, an internal gear 62 disposed on the outer edge, and a disc-shaped carrier 30. The disc-shaped carrier 30 is meshed at its inner periphery with the sun gear 61, while being meshed at its outer periphery with the internal gear 62. Further, the disc-shaped carrier 30 accommodates and holds a single or a plurality of the plate glass materials G (workpiece/workpieces). On the bottom platen 50, the carrier 30 rotates and revolves as a planetary gear, while the plate glass material/materials G and the bottom platen 50 are moved relatively to each other. When the sun gear 61 is rotated in the counter-clockwise (CCW) direction, for instance, the carrier 30 is rotated in the clockwise (CW) direction. The internal gear 62 is accordingly rotated in the CCW direction. As a result, relative motion is produced between the polisher pad 10 and the plate glass material/materials G. Likewise, the plate glass material/materials G and the top platen 40 may be moved relatively to each other.

In the course of the aforementioned relative motion, the top platen 40 is pressed onto the plate glass material/materials G (i.e., in the vertical direction) with a predetermined load. In other words, the polisher pads 10 are pressed onto the plate glass material/materials G. Further, a pump (not illustrated in the figure) is configured to supply a slurry from a slurry supply tank 71 to spaces between the plate glass material/materials G and the polisher pads 10 through a single or plurality of pipes 72. The principal faces of the plate glass material/materials G are polished by means of an abrasive contained in the slurry. The slurry, herein used for polishing the plate glass material/materials G, is preferably discharged from the top and bottom platens and is then returned to the slurry supply tank 71 through a single or plurality of return pipes (not illustrated in the figure) to be reused.

It should be noted that, in this polisher device, it is preferable to adjust the load of the top platen 40 applied onto the plate glass material/materials G in order to set a desired polishing load with respect to the plate glass material/materials G.

{Slurry}

Next, the slurry to be used in the polisher device of the present embodiment will be explained.

The slurry of the present embodiment is characterized by containing the following components:

(A) an abrasive made of granular zirconia (zirconium dioxide; fine particles of ZrO₂);

(B) a first additive including at least one type of compound selected from the group consisting of phosphates, sulfonates, polycarboxylic acids, and polycarboxylates; and

(C) a second additive including a re-aggregation inhibitor.

Further, with the aim of improving the dispersibility of the abrasive, the slurry preferably contains: (D) a third additive including granular silicon dioxide and/or titanium dioxide having a smaller particle size than the aforementioned zirconia.

A slurry is produced by mixing the aforementioned abrasive and the first to third additives into a liquid, such as water or an alkaline solution.

Herein, the objective of using zirconia as loose abrasive grains in the slurry for the present step is to substitute for cerium oxide, a conventionally used abrasive. However, if a magnetic disk glass substrate is polished by using a slurry containing loose abrasive grains consisting only of zirconia, then polishing performance—such as the polishing rate of the principal faces of the glass substrate, accuracy in surface asperities on the principal faces, the presence/absence of scratches on the principal faces, and production stability (amount of reduction in polishing rate from batch to batch)—will deteriorate compared to cases of using cerium oxide.

This is because, if only zirconia is mixed to the slurry, then the zirconia particles are prone to turn into hard cake (i.e., the once-dispersed abrasive grains in the abrasive bond together firmly and become hard to re-disperse) during polishing or inside the slurry supply tank. When hard cake is formed, the particle size distribution changes over time from the initial sharp state to a-broad state. Thus, the number of abrasive grains contributing to polishing decreases (i.e., only large particles contribute to the polishing, while small polisher particles cannot contribute to the polishing efficiently). This deteriorates the polishing rate and also impairs the quality of the substrate.

Further, the formation of hard cake is also unfavorable from the standpoint of the creation of scratches on the principal faces of the plate glass material to be polished. For example, in a case where the polisher pad 10 is set so as to apply a predetermined load on the plate glass material G, i.e., the workpiece, in the polisher device illustrated in FIG. 1, if the characteristic of the particle size distribution becomes relatively gentle across all particle sizes (i.e. if the particle size distribution becomes broad), then there will be a decrease in the number of abrasive grains that contact the workpiece and substantially exert a polishing effect. This results in an increase in the load per particle with respect to the principal face of the workpiece, thus making it likely to cause scratches on the principal face.

Further, in cases where the slurry is reused by being circulated to the slurry supply tank after use, the zirconia particles that have turned into hard cake will sediment, for example, to the bottom of the tank, and the substantial concentration of zirconia in the slurry (i.e., zirconia that is used for polishing) will decrease, thus reducing the polishing processing speed. Furthermore, portions of zirconia clusters, which have once turned into hard cake at the bottom of the tank, may exfoliate in the tank, in which case the exfoliated hard cake passes through the pipe(s) and is used for processing the plate glass material. This will make it likely to cause scratches on the principal faces of the plate glass material.

In summary, if the zirconia particles turn into hard cake, then the polishing rate and accuracy in surface asperities on the principal faces deteriorate, and scratches are prone to occur on the principal faces. So, the slurry of the present embodiment is mixed with the first to third additives with the aim of sufficiently dispersing the zirconia particles, which are prone to turn into hard cake, and also preventing re-aggregation.

It should be noted that, from the standpoint of polishing performance etc. of the abrasive with respect to the glass material, it is preferable to make the slurry into an alkaline solution (with a pH of around 6 to 12) by adding, for example, potassium hydroxide or sodium hydroxide to the slurry.

Below, we will explain in further detail the abrasive and the first to third additives contained in the slurry of the present embodiment.

(A) Abrasive

The slurry preferably contains 5 to 20 wt % of the abrasive made of granular zirconia.

The average particle size (D₅₀) of zirconia serving as an abrasive (abrasive grains for polishing) is preferably 0.2 to 10 μm, more preferably 0.5 to 2 μm, and further preferably 0.8 to 1.4 μm, from the standpoint of: providing a sufficient polishing rate (e.g., 0.5 μm/minute); not creating flaws that can be observed by inspection with a beam-condensing lamp in terms of surface asperities on the plate glass material G; and ensuring polishing performance that achieves a waviness of 1 nm or less and a micro-waviness of 2 nm or less. Herein, the average particle size (D₅₀) is the particle size at a point where the cumulative volume frequency becomes 50%, the cumulative volume frequency being found by regarding the total volume of groups of particles in the particle size distribution as 100%.

The standard deviation (SD) of the particle sizes of zirconia is preferably 1 lam or less, more preferably 0.5 μm or less, and further preferably 0.2 μm or less.

It should be noted that the waviness can be measured by using, for example, “OptiFLAT” (a product from KLA-Tencor Corporation), while the micro-waviness can be measured by using, for example, “Thot” (a product from Polytec).

(B) First Additive

The slurry preferably contains 0.01 to 5 wt % of the first additive, which includes at least one type of compound selected from the group consisting of phosphates, sulfonates, polycarboxylic acids, and polycarboxylates.

The first additive functions as a dispersant for the granular zirconia. That is, the first additive is mixed to the slurry with the aim of chemically coating the surface of the zirconia abrasive grains so as to facilitate the separation of the zirconia abrasive grains from one another (i.e., making the abrasive grains less prone to aggregation), particularly during polishing processing. Mixing too much of the first additive will conversely give rise to aggregation, so the upper limit amount for mixing the first additive is determined from this standpoint.

Among the aforementioned phosphates, sulfonates, polycarboxylic acids, and polycarboxylates, polycarboxylic acids are preferable, in terms that it is possible to further enhance the effect of inhibiting hard-caking (described later), in addition to the effect as a dispersant.

Examples of phosphates include sodium hexametaphosphate, sodium pyrophosphate, potassium pyrophosphate, and the like.

Examples of sulfonates include dodecylbenzene sulfonates, alkylbenzene sulfonates, linear alkylbenzene sulfonates, and the like.

If the concentration of phosphate-based compounds added as the first additive is too high, then the polishing rate may deteriorate because the amount of adsorption around the zirconia abrasive grains increases. If the concentration of polycarboxylic acid-based compounds added as the first additive is too high, then the polishing rate may deteriorate because the viscosity around the zirconia abrasive grains becomes too high, and also the polycarboxylic acid may remain as a foreign substance. Thus, the percentage by weight of the first additive with respect to the abrasive is preferably 0.1 to 5 wt %, and further preferably 0.5 to 2.5 wt %. Accordingly, high dispersibility of zirconia particles can be achieved without deteriorating the polishing rate.

(C) Second Additive

The slurry preferably contains 0.01 to 5 wt % of the second additive, which includes a re-aggregation inhibitor.

The dispersibility of zirconia particles can be improved by the aforementioned first additive. However, as a side effect, the zirconia particles tend to sediment inside the slurry supply tank in a state where the particle size of the zirconia particles is comparatively uniform (i.e., in a state where the particle size distribution is biased at a certain particle size). Because the particle size is uniform, the density of the fine particles becomes high, and thus, stiffer hard cake (deposit) is prone to sediment to the bottom of the tank. If portions of the sedimented hard cake exfoliate from the bottom of the tank and are supplied via the pipe(s) to the polishing processing, then this will make it likely to cause scratches on the principal faces of the plate glass material to be polished.

So, a re-aggregation inhibitor (a hard-caking inhibitor) is added to the slurry of the present embodiment to increase the viscosity in the periphery of the zirconia particles in the slurry by means of the steric hindrance effect of the re-aggregation inhibitor. This makes the zirconia particles less prone to sedimentation, or delays the sedimentation thereof, and thus makes the zirconia particles less prone to aggregation, particularly when the slurry is in a static state where it is not used for polishing processing (for example, when the slurry is inside the slurry supply tank 71 of FIG. 1), or when the slurry is in a state where it has been supplied to the plate glass material undergoing the polishing processing but is not working in this processing.

The type of the re-aggregation inhibitor is not particularly limited; it may be selected as appropriate from, for example, saccharides or fibers such as cellulose (microcrystalline), carboxymethyl cellulose, maltose, and fructose.

It should be noted that, if the concentration of the second additive is too high, then the polishing rate may deteriorate because the viscosity around the zirconia abrasive grains becomes too high. Thus, it is preferable not to include too much second additive.

The weight ratio between the first additive and the second additive (first additive/second additive) is preferably 0.5 to 2, and further preferably 0.75 to 1.5. Accordingly, it is possible to inhibit the formation of hard cake as well as inhibit reductions in polishing rate. For example, it is possible to inhibit the reduction in polishing rate, from the polishing rate of the first batch, after performing polishing for ten batches.

The above described, with reference to FIG. 1, an example of a polisher device in which the slurry is circulated and reused. However, in cases where the slurry is discarded after use without being reused, then the second additive does not have to be mixed to the slurry. That is, in order to reuse the slurry, it is necessary to provide filters, pumps, etc., in the middle of the pipes for returning the slurry to the tank, as described above. If the slurry is circulated and used for a long time, then zirconia particles will accumulate, for example, in the filters or inside the pumps, which may give rise to hard-caking. To inhibit hard-caking, it is preferable to add the second additive as a re-aggregation inhibitor (hard-caking inhibitor). However, in cases where the slurry is not circulated, the zirconia particles are less prone to turn into hard cake, so the second additive does not have to be mixed to the slurry.

In other words, the second additive of the present embodiment is preferably added to the slurry in cases where the slurry is used in a circulating fashion.

(D) Third Additive

The slurry preferably contains 0.05 to 5 wt % of a third additive that includes granular silicon dioxide (SiO₂) and/or titanium dioxide (TiO₂) having a smaller particle size than the aforementioned zirconia. Further, powdered quartz may be added as the third additive.

The third additive functions as a dispersant for the granular zirconia owing to its steric hindrance effect. That is, the third additive enters between the zirconia abrasive grains and functions to prevent the abrasive grains from bonding with one another, particularly during polishing processing. It should be noted that because the amount of the third additive mixed to the slurry is very small, the third additive hardly contributes to the polishing per se.

In order for the third additive to enter between the zirconia abrasive grains and prevent bonding thereof and to effectively exert its bonding prevention function as described above, it is preferable that the particle size of silicon dioxide and/or titanium dioxide to be mixed as the third additive is smaller than the particle size of zirconia serving as the abrasive. For example, if the average particle size (D₅₀) of zirconia is 0.2 to 10 μm, then the particle size (average particle size) of silicon dioxide and/or titanium dioxide included in the third additive is set to 10 to 100 nm.

Silicon dioxide may be selected from colloidal silica, fumed silica, fused silica, or the like, as appropriate.

(7) Chemical Strengthening Step

Next, the annular plate glass material is chemically strengthened after the first polishing step.

For example, a mixed liquid containing (60 wt % of) potassium nitrate and (40 wt % of) sodium sulfate may be used as a chemical strengthening liquid. In the chemical strengthening, the chemical strengthening liquid is heated to e.g. 300° C. to 400° C., and a washed annular plate glass material preliminarily heated to e.g. 200° C. to 300° C. is submerged into the chemical strengthening liquid for e.g. 3 to 4 hours. To chemically strengthen the entire principal faces of a plurality of annular plate glass materials, the submerging is preferably executed under the condition that the annular plate glass materials are accommodated in holders such that they are held at the edge faces thereof.

By thus submerging the annular plate glass material into the chemical strengthening liquid, lithium ions and sodium ions on the outermost layer of the annular plate glass material are respectively substituted by sodium ions and potassium ions that are present in the chemical strengthening liquid and have relatively large ionic radii. Accordingly, the annular plate glass material is strengthened. It should be noted that the chemically strengthened annular plate glass material is washed. For example, the chemically strengthened annular plate glass material is washed with sulfuric acid and is then washed with pure water or the like.

(8) Second (Final) Polishing Step

Next, a second polishing step is executed for the annular plate glass material, which has been chemically strengthened and sufficiently washed. In the second polishing step, the removal stock is set to be around 1 μm, for example. The second polishing step is intended to mirror-polish the principal faces of the annular plate glass material. For example, the polisher device used in the first polishing step is used in this second polishing step. In doing so, there are differences from the first polishing step in that the type of loose abrasive grains and the particle size thereof are different and that the hardness of the resin polisher is different.

For example, fine particles (particle size: around 10 to 50 nm in diameter) of e.g. colloidal silica mixed in a slurry are used as loose abrasive grains to be used in this second polishing step.

The polished annular plate glass material is washed with a neutral detergent, pure water, IPA or etc. Accordingly, a magnetic disk glass substrate is obtained.

{Magnetic Disk}

A magnetic disk is obtained as follows by using the magnetic disk glass substrate (referred to hereinafter as “glass substrate”).

For example, the magnetic disk has a structure in which multiple layers, including at least an adhesive layer, an underlying layer, a magnetic layer (magnetic recording layer), a protective layer, and a wetting layer, are sequentially laminated in this order from bottom to top on a principal face of the glass substrate.

For example, the substrate is introduced into a vacuumed film forming device, and the adhesive layer, the underlying layer, and the magnetic layer are sequentially formed atop the principal face of the substrate in an Ar atmosphere by means of DC magnetron sputtering. For example, CrTi may be used as the adhesive layer, while CrRu may be used as the underlying layer. After the formation of the layers, the protective layer is formed, for instance, by using C₂H₄ by means of a CVD method. Next, a nitriding treatment is executed in the same chamber by introducing nitrogen into the surface. Accordingly, the magnetic recording medium can be formed. Subsequently, the wetting layer can be formed by applying e.g. PFPE (polyfluoropolyether) onto the protective layer by means of a dip coating method.

### EXAMPLES

The present invention will be hereinafter further explained by working examples. It should be noted that the present invention is not limited to embodiments described in the working examples.

(1) Fabrication of Molten Glass

Mixture material was prepared by weighing and mixing raw materials for obtaining a glass with the following composition. The mixture material was put into a melting container and was therein heated, melted, clarified, and stirred. Thus, a uniform molten glass without bubbles and unmelted substances was fabricated. It was confirmed that the obtained glass did not include bubbles and unmelted substances, deposition of crystals, and impurities such as refractory substances and/or platinum forming the melting container.

{Glass Composition}

The prepared glass was aluminosilicate glass having a composition containing, in an oxide-based conversion indicated in mol %: 50 to 75% of SiO₂; 1 to 15% of Al₂O₃; a total of 12 to 35% of at least one type of component selected from Li₂O, Na₂O, and K₂O; a total of 0 to 20% of at least one type of component selected from MgO, CaO, SrO, BaO, and ZnO; and a total of 0 to 10% of at least one type of component selected from ZrO₂, TiO₂, La₂O₃, Y₂O₃, Ta₂O₅, Nb₂O₅, and HfO₂.

(2) Fabrication of Plate Glass Material

The aforementioned molten glass, clarified and homogenized, was poured from the pipe(s) onto a bottom mold for press-molding at a predetermined flow rate. The poured molten glass was then cut by a cutting blade for obtaining a predetermined amount of molten glass gob on the bottom mold. The bottom mold with the molten glass gob disposed thereon was immediately transported from the position below the pipe(s) to a predetermined position. The molten glass gob disposed on the bottom mold was press-molded in a thin disc shape using a top mold opposed to the bottom mold and a barrel. The press-molded product was cooled down to a temperature not causing deformation of the press-molded product. The cooled press-molded product was removed out of the molds, and was then annealed. Subsequently, a lapping processing was executed for the plate glass material obtained by the press-molding. In the lapping processing, alumina abrasive grains (with a particle size of #1000) were used as loose abrasive grains.

(3) Coring and Chamfering

An inner hole was formed in the center part of the disc-shaped glass material by using a cylindrical diamond drill, to obtain an annular glass substrate (i.e., coring). Then, the inner and outer peripheral edge faces of the annular glass substrate were ground by means of a diamond abrasive block, to execute a predetermined chamfering processing (i.e., chamfering). In this way, a 65-mm-dia. glass substrate was prepared.

(4) Edge Face Polishing Step

Next, mirror polishing was executed for the edge faces of the annular glass substrate by means of a brush polishing method. Slurry (loose abrasive grains), containing cerium oxide abrasive grains, was herein used as the polishing abrasive grains. Through the edge face polishing step, the edge faces of the glass substrate were processed to a mirror-surface state capable of preventing the creation of dust such as particles.

(5) First Polishing Step for Principal Face

(5-1) Slurry and Evaluation Thereof No. 1

A plate glass material was set in the polisher device illustrated in FIG. 1 and was polished by using one of the slurries indicated as Reference Example, Comparative Examples, and Working Examples as shown in Table 1. The polishing performance of each slurry was evaluated. It should be noted that the slurries were circulated and reused.

Each slurry shown in Table 1 and to be used in the polishing step was prepared by mixing, into pure water, 5 to 20 wt % of zirconia (ZrO₂) as the abrasive, 0.01 to 5 wt % of sodium hexametaphosphate as the first additive, 0.01 to 5 wt % of cellulose as the second additive, and 0.1 to 20 wt % of colloidal silica as the third additive, and sufficiently stirring the mixture. The average particle size of zirconia was 0.8 to 1.4 μm, and the average particle size of colloidal silica serving as the third additive was 10 to 100 nm.

TABLE 1

| | | | | | Polishing performance | | | |
|---|---|---|---|---|---|---|---|---|
| | | Additives | | | | Surface | Presence/ | |
| | | First | Second | Third | | asperities on | absence of | Production |
| | Abrasive | additive | additive | additive | Polishing rate | principal face | scratches | stability |
| Reference Example 1 | CeO₂ | Yes | Yes | — | OK | OK | OK | OK |
| Comparative Example 1 | ZrO₂ | — | — | — | NG | NG | NG | NG |
| Comparative Example 2 | ZrO₂ | Yes | — | — | OK | NG | NG | NG |
| Comparative Example 3 | ZrO₂ | — | — | Yes | NG | NG | NG | NG |
| Comparative Example 4 | ZrO₂ | Yes | — | Yes | OK | NG | NG | NG |
| Working Example 1 | ZrO₂ | Yes | Yes | — | OK | OK | OK | OK |
| Comparative Example 5 | ZrO₂ | — | Yes | Yes | NG | NG | NG | OK |
| Working Example 2 | ZrO₂ | Yes | Yes | Yes | OK | OK | OK | OK |

OK: Good.
NG: Poor

In the evaluation of polishing performance shown in Table 1, “OK” indicates that the following criteria are met, and “NG” indicates that they are not.
Polishing rate: The polishing rate of the first batch is 0.5 μm/minute or higher.
Surface asperities on principal face: The waviness is 1 nm or less, and the micro-waviness is 2 nm or less.
Presence/absence of scratches: There are no scratches' on the principal face.
Production stability: The percentage of reduction in polishing rate from the first batch to the tenth batch is 40% or less.

It should be noted that, in the aforementioned criteria, “waviness” is the arithmetic mean height (Wa) calculated as waviness having wavelengths of 0.1 mm to 5 mm, inclusive, in an area within the radius of 16.0 to 29.0 mm, found by using a white-light interference-microscope type profilometer (“Optiflat”, a product from KLA-Tencor Corporation). “Micro-waviness” is the RMS value (Rq) calculated as waviness having wavelengths of 109 to 500 μm in an area within the radius of 14.0 to 31.5 mm over the entire principal face, found by using “Model-4224”, a product from Polytec.

The presence/absence of scratches was inspected visually.

As can be understood from Table 1, the slurries according to the Working Examples, which contained zirconia as the abrasive and contained both of the first and second additives, had substantially the same polishing performance compared to a conventional slurry containing cerium oxide as the abrasive. It was verified that the slurries according to the Working Examples can be used in the polishing step in place of conventional slurries containing cerium oxide. Further, the polishing rate improved by adding the third additive.

(5-2) Slurry and Evaluation Thereof No. 2

A plate glass material was set in the polisher device illustrated in FIG. 1 and was polished by using one of the slurries indicated as Reference Examples and Conventional Example as shown in Table 2. The polishing performance of each slurry was evaluated. It should be noted that the slurries were circulated and reused.

Each slurry shown in Table 2 and to be used in the polishing step was prepared by mixing, into pure water, 15 wt % of cerium oxide (CeO₂) as the abrasive, 0.01 to 5 wt % of sodium hexametaphosphate as the first additive, and 0.01 to 5 wt % of cellulose as the second additive, and sufficiently stirring the mixture. The average particle size (D₅₀) of cerium oxide was 1.0 μm.

TABLE 2

| | | | | | Polishing performance | | | |
|---|---|---|---|---|---|---|---|---|
| | | Additives | | | | Surface | Presence/ | |
| | | First | Second | Third | | asperities on | absence of | Production |
| | Abrasive | additive | additive | additive | Polishing rate | principal face | scratches | stability |
| Reference Example 1 | CeO₂ | Yes | Yes | — | OK | OK | OK | OK |
| Reference Example 2 | CeO₂ | Yes | — | — | OK | OK | OK | OK |
| Reference Example 3 | CeO₂ | — | Yes | — | OK | OK | OK | OK |
| Conventional Example | CeO₂ | — | — | — | OK | OK | OK | OK |

OK: Good.
NG: Poor

As can be understood from Table 2, in cases where cerium oxide was used as the abrasive, there was no change in polishing performance. regardless of whether or not the first additive and/or the second additive were/was added. From Tables 1 and 2, it is understood that the positive effect on the polishing performance achieved by the addition of the first and second additives is caused by using zirconia as the abrasive.

(5-3) Slurry and Evaluation Thereof No. 3

A plate glass material was set in the polisher device illustrated in FIG. 1 and was polished by using one of the slurries indicated as Working Examples as shown in Table 3. The polishing rate was measured, and the plate glass material was washed with a neutral detergent and IPA. Then, the plate glass material was subjected to a chemical strengthening step for 4 hours at 300° C. with a molten salt including potassium nitrate (60 wt %) and sodium sulfate (40 wt %). Further, the plate glass material was: subjected to a second polishing step with a removal stock of 3 μm by using a suede polisher pad and a slurry containing, in pure water, 15 wt % of colloidal silica abrasive grains having an average particle size of 50 nm; washed with a neutral detergent, an alkaline detergent, and IPA; and then dried. In this way, a 2.5-inch magnetic disk glass substrate (inner diameter: 20 mm; outer diameter: 65 mm; plate thickness: 0.8 mm) was prepared.

The prepared magnetic disk glass substrate was subjected to a film forming process by using a sputtering machine, and thus made into a magnetic disk. The magnetic disk was subjected to a DFH touchdown test.

The film forming process was performed as follows.

An adhesive layer, a soft magnetic layer, an underlying layer, a recording layer, a protective layer, and a wetting layer were sequentially formed in this order on the magnetic disk glass substrate. A 10-nm layer of Cr-50Ti was formed as the adhesive layer. 20-nm layers of 92Co-3Ta-5Zr, with a 0.7-nm Ru layer sandwiched therebetween, were formed as the soft magnetic layer. An 8-nm layer of Ni-5W and a 20-nm layer of Ru were formed as the underlying layer. A 15-nm layer of 90(72Co-10Cr-18Pt)-5(SiO₂)-5(TiO₂) and a 6-nm layer of 62Co-18Cr-15Pt-5B were formed as the recording layer. As the protective layer, a 4-nm layer was formed through CVD by using C₂H₄, and the outermost layer was subjected to a nitriding treatment. As the wetting layer, a 1-nm layer was formed through a dip coating method by using PFPE.

The DFH touchdown test is a touchdown test of a DFH head element part performed with respect to the prepared magnetic disk by using an HDF tester (Head/Disk Flyability Tester) produced by Kubota Comps Corporation. In this test, the distance when the head element part contacts the magnetic disk surface is evaluated by making the element part slowly protrude by using a DFH mechanism and detecting the contact with the magnetic disk surface by using an AE sensor. The greater the protrusion amount, the further the magnetic spacing is reduced, and the more the magnetic disk is suited for increasing recording density. The head used was a DFH head for 320 GB/P magnetic disks (2.5-inch size). The flying height when the element part is not protruded is 10 nm. The other conditions were set as follows:
Evaluation radius: 22 mm;
Number of revolutions of the magnetic disk: 5400 RPM;
Temperature: 25° C.;
Humidity: 60%.

The evaluation criteria for the DFH touchdown test were set as follows, in accordance with the protrusion amount of the head element part. All of the Examples had at least the minimum performance (reading/writing performance) required for a magnetic disk.

Excellent: 8.0 nm or greater;

Good: 7.0 nm or greater and less than 8.0 nm;

Fair: Less than 7.0 nm.

Next, an evaluation was made for verifying the influence on polishing performance for cases where the zirconia abrasive grains contained in the slurry had difference average particle sizes (D₅₀). It should be noted that the slurries were circulated and reused.

Each slurry shown in Table 3 and to be used in the polishing step contained: 15 wt % of zirconia (ZrO₂) as the abrasive; 0.1 wt %, in percentage by weight with respect to the abrasive, of sodium hexametaphosphate as the first additive; and cellulose as the second additive in an amount such that the weight ratio between the first additive and the second additive (first additive/second additive) was 1. Each slurry was prepared by mixing these components into pure water and sufficiently stirring the mixture. It should be noted that the average particle size (D₅₀) and the standard deviation (SD) of the zirconia abrasive grains were measured by using a particle size and particle size distribution measuring instrument (“Nanotrac UPA-EX150”, a product from Nikkiso Co., Ltd.) by means of a light scattering method. Herein, the average particle size (D₅₀) is the particle size at a point where the cumulative volume frequency becomes 50%, the cumulative volume frequency being found by regarding the total volume of groups of particles in the particle size distribution, as measured by the light scattering method, as 100%.

TABLE 3

| | | Average | | | | | |
|---|---|---|---|---|---|---|---|
| | | particle size | Additives | | | Evaluation items | |
| | | D₅₀ | First | Second | Third | DFH | Polishing |
| | Abrasive | [μm] | additive | additive | additive | touchdown test | rate |
| Working Example 3 | ZrO₂ | 0.1 | Yes | Yes | — | Good | Fair |
| Working Example 4 | ZrO₂ | 0.2 | Yes | Yes | — | Good | Good |
| Working Example 5 | ZrO₂ | 0.3 | Yes | Yes | — | Excellent | Excellent |
| Working Example 6 | ZrO₂ | 1.0 | Yes | Yes | — | Excellent | Excellent |
| Working Example 7 | ZrO₂ | 10 | Yes | Yes | — | Good | Good |
| Working Example 8 | ZrO₂ | 15 | Yes | Yes | — | Fair | Good |

The evaluation of polishing rate shown in Table 3 was made by measuring the polishing rate of the first batch and evaluating the rate according to the following criteria. “Excellent”, “Good”, and “Fair” were considered acceptable.

Excellent: Higher than 1.0 μm/minute;

Good: Higher than 0.7 μm/minute and lower than or equal to 1.0 μm/minute;

Fair: Higher than 0.5 μm/minute and lower than or equal to 0.7 μm/minute;

Poor: Lower than or equal to 0.5 μm/minute.

As can be understood from Table 3, both the polishing rate and the DFH touchdown test were highly evaluated in cases where the average particle size (D₅₀) of the zirconia abrasive grains was within the range of 0.2 to 10 μm. It is considered that the evaluation regarding the DFH touchdown test was divided due to the influence of extremely small flaws and scratches that were formed on the principal face at the time of ZrO₂ polishing and that could not be visually observed. That is, it is considered that the difference in the evaluation results regarding the DFH touchdown test was caused by the size and number of extremely small flaws and scratches.

(5-4) Slurry and Evaluation Thereof No. 4

A plate glass material was set in the polisher device illustrated in FIG. 1 and was polished by using one of the slurries indicated as Working Examples as shown in Table 4. The polishing performance of each slurry was evaluated. It should be noted that the slurries were circulated and reused.

Each slurry shown in Table 4 and to be used in the polishing step contained: 15 wt % of zirconia (ZrO₂) as the abrasive; and certain percentages by weight, with respect to the abrasive, of sodium hexametaphosphate as the first additive and cellulose as the second additive in amounts that were set such that the weight ratio between the two (first additive/second additive) varied. Each slurry was prepared by mixing these components into pure water and sufficiently stirring the mixture. The average particle size of zirconia was 0.8 to 1.4 μm.

TABLE 4

| | | Additives | | | | Evaluation |
|---|---|---|---|---|---|---|
| | | First | Second | Weight ratio | | item |
| | | additive | additive | (First additive/Second | Third | Production |
| | Abrasive | [wt %] | [wt %] | additive) | additive | stability |
| Working Example 9 | ZrO₂ | 0.10 | 1.00 | 0.1 | — | Fair |
| Working Example 10 | ZrO₂ | 0.10 | 0.20 | 0.5 | — | Good |
| Working Example 11 | ZrO₂ | 0.10 | 0.13 | 0.75 | — | Excellent |
| Working Example 12 | ZrO₂ | 0.10 | 0.07 | 1.5 | — | Excellent |
| Working Example 13 | ZrO₂ | 0.10 | 0.05 | 2 | — | Good |
| Working Example 14 | ZrO₂ | 0.10 | 0.03 | 3.3 | — | Fair |

The evaluation of production stability shown in Table 4 was made by calculating the percentage of reduction of the polishing rate of the tenth batch from the polishing rate of the first batch, and evaluating the reduction rate according to the following criteria. “Excellent”, “Good”, and “Fair” were considered acceptable.

Excellent: 20% or lower;

Good: Higher than 20% and lower than or equal to 30%;

Fair: Higher than 30% and lower than or equal to 40%;

Poor: 40% or higher.

As can be understood from Table 4, the production stability was good in cases where the weight ratio between the first additive and the second additive (first additive/second additive) was within the range of 0.5 to 2, and was even better in cases where the weight ratio was within the range of 0.75 to 1.5. It is considered that the production stability deteriorated slightly when the weight ratio (first additive/second additive) was 0.1, because the viscosity around the zirconia abrasive grains became too high and the polishing rate decreased. It is considered that the production stability deteriorated slightly when the weight ratio (first additive/second additive) was 3.3, because the amount of the second additive was too small compared to that of the first additive, and thus the effect of inhibiting hard-caking dropped.

It should be noted that, in terms of surface asperities on the principal face and the presence/absence of scratches, all of Working Examples 9 to 14 were evaluated “OK” according to the aforementioned criteria.

The method for manufacturing a glass substrate for a magnetic disk and the method for manufacturing a magnetic disk of the present invention were described in detail above, but it goes without saying that the present invention is not limited to the foregoing embodiments, and various improvements/modifications can be made thereto within a scope that does not depart from the gist of the present invention.

### REFERENCE SIGNS LIST

10: Polisher pad
30: Carrier
40: Top platen
50: Bottom platen
61: Sun gear
62: Internal gear
71: Slurry supply tank
72: Pipe

1. A method for manufacturing a glass substrate for a magnetic disk, the method comprising
polishing a principal face of a glass material by using a slurry, the slurry containing:
an abrasive made of granular zirconia;
a first additive including at least one type of compound selected from the group consisting of phosphates, sulfonates, polycarboxylic acids, and polycarboxylates; and
a second additive including a re-aggregation inhibitor.

2. The method for manufacturing a glass substrate for a magnetic disk recited in claim 1, wherein the average particle size (D₅₀) of said zirconia is from 0.2 to 10 μm.

3. The method for manufacturing a glass substrate for a magnetic disk recited in claim 1, wherein said slurry contains 5 to 20 wt % of said abrasive, 0.01 to 5 wt % of said first additive, and 0.01 to 5 wt % of said second additive.

4. The method for manufacturing a glass substrate for a magnetic disk recited in claim 1, wherein said re-aggregation inhibitor is at least one type of compound selected from the group consisting of cellulose, carboxymethyl cellulose, maltose, and fructose.

5. The method for manufacturing a glass substrate for a magnetic disk recited in claim 1, wherein said slurry further contains a third additive including granular silicon dioxide and/or titanium dioxide having a smaller particle size than said zirconia.

6. The method for manufacturing a glass substrate for a magnetic disk recited in claim 5, wherein the average particle size (D₅₀) of said silicon dioxide and/or titanium dioxide is from 10 to 100 nm.

7. The method for manufacturing a glass substrate for a magnetic disk recited in claim 5, wherein said slurry contains 0.1 to 20 wt % of said third additive.

8. The method for manufacturing a glass substrate for a magnetic disk recited in claim 1, wherein the pH of said slurry is from 6 to 12.

9. The method for manufacturing a glass substrate for a magnetic disk recited in claim 1, wherein the glass substrate for a magnetic disk is made of aluminosilicate glass having a composition containing, in an oxide-based conversion indicated in mol %:
50 to 75% of SiO₂;
1 to 15% of Al₂O₃;
a total of 12 to 35% of at least one type of component selected from Li₂O, Na₂O, and K₂O;
a total of 0 to 20% of at least one type of component selected from MgO, CaO, SrO, BaO, and ZnO; and
a total of 0 to 10% of at least one type of component selected from ZrO₂, TiO₂, La₂O₃, Y₂O₃, Ta₂O₅, Nb₂O₅, and HfO₂.

10. A method for manufacturing a magnetic disk, the method comprising
forming at least a magnetic layer on a glass substrate for a magnetic disk manufactured according to the method for manufacturing a glass substrate for a magnetic disk recited in claim 1.

11. The method for manufacturing a glass substrate for a magnetic disk recited in claim 2, wherein said slurry contains 5 to 20 wt % of said abrasive, 0.01 to 5 wt % of said first additive, and 0.01 to 5 wt % of said second additive.

12. The method for manufacturing a glass substrate for a magnetic disk recited in claim 2, wherein said re-aggregation inhibitor is at least one type of compound selected from the group consisting of cellulose, carboxymethyl cellulose, maltose, and fructose.

13. The method for manufacturing a glass substrate for a magnetic disk recited in claim 2, wherein said slurry further contains a third additive including granular silicon dioxide and/or titanium dioxide having a smaller particle size than said zirconia.

14. The method for manufacturing a glass substrate for a magnetic disk recited in claim 6, wherein said slurry contains 0.1 to 20 wt % of said third additive.

15. The method for manufacturing a glass substrate for a magnetic disk recited in claim 2, wherein the pH of said slurry is from 6 to 12.

16. The method for manufacturing a glass substrate for a magnetic disk recited in claim 2, wherein the glass substrate for a magnetic disk is made of aluminosilicate glass having a composition containing, in an oxide-based conversion indicated in mol %:
50 to 75% of SiO₂;
1 to 15% of Al₂O₃;
a total of 12 to 35% of at least one type of component selected from Li₂O, Na₂O, and K₂O;
a total of 0 to 20% of at least one type of component selected from MgO, CaO, SrO, BaO, and ZnO; and
a total of 0 to 10% of at least one type of component selected from ZrO₂, TiO₂, La₂O₃, Y₂O₃, Ta₂O₅, Nb₂O₅, and HfO₂.

17. A method for manufacturing a magnetic disk, the method comprising
forming at least a magnetic layer on a glass substrate for a magnetic disk manufactured according to the method for manufacturing a glass substrate for a magnetic disk recited in claim 2.

18. The method for manufacturing a glass substrate for a magnetic disk recited in claim 3, wherein said re-aggregation inhibitor is at least one type of compound selected from the group consisting of cellulose, carboxymethyl cellulose, maltose, and fructose.

19. The method for manufacturing a glass substrate for a magnetic disk recited in claim 3, wherein said slurry further contains a third additive including granular silicon dioxide and/or titanium dioxide having a smaller particle size than said zirconia.

20. The method for manufacturing a glass substrate for a magnetic disk recited in claim 3, wherein the pH of said slurry is from 6 to 12.
